(19) United States
(12) Patent Application Publication
(10) Pub. No.: US 2011/0100020 A1
(43) Pub. Date: May 5, 2011

(54) APPARATUS AND METHOD FOR TURBINE ENGINE COOLING

(75) Inventors: Hua Zhang, Greer, SC (US); Yang Liu, Simpsonville, SC (US)

(73) Assignee: GENERAL ELECTRIC COMPANY, Schenectady, NY (US)

(21) Appl. No.: 12/609,206

(22) Filed: Oct. 30, 2009

(51) Int. Cl. F02C 7/12

(52) U.S. Cl. 60/806

(57) ABSTRACT

A turbine engine comprises a turbine housing, a turbine disposed in the turbine housing that is configured to receive hot combustion gas, a turbine component subject to thermal energy from the hot combustion gas and a cooling system disposed externally of the turbine housing and having a cooling medium disposed therein. A heat pipe has a high temperature end in communication with the turbine component and a low temperature end extending out of the turbine housing in communication with the cooling medium in the cooling system for transferring the thermal energy from the component to the cooling medium.

### BACKGROUND OF THE INVENTION

The subject matter disclosed herein relates to gas turbine engines and, more particularly, to temperature and performance management therein.

In a gas turbine engine, air is pressurized in a compressor and mixed with fuel in a combustor for generating hot combustion gas that flows downstream through one or more turbine stages. A turbine stage includes a stationary nozzle having stator vanes that guide the combustion gas through a downstream row of turbine rotor blades. The turbine rotor blades extend radially outwardly from a supporting rotor that is powered by extracting energy from the gas.

A first stage turbine nozzle receives hot combustion gas from the combustor and directs it to the first stage turbine rotor blades for extraction of energy therefrom. A second stage turbine nozzle may be disposed downstream from the first stage turbine rotor blades, and is followed by a row of second stage turbine rotor blades that extract additional energy from the combustion gas. Additional stages of turbine nozzles and turbine rotor blades may be disposed downstream from the second stage turbine rotor blades.

As energy is extracted from the combustion gas, the temperature of the gas is correspondingly reduced. However, since the gas temperature is relatively high, the turbine stages are typically cooled by a coolant such as compressed air that is diverted from the compressor and through hollow vane and blade airfoils for cooling these internal components of the turbine. However, since the cooling air is diverted from use by the combustor, the quantity of cooling air extracted from the compressor has a direct influence on the overall efficiency of the engine.

It is therefore desired to improve the efficiency with which heat is removed from the turbine stages, without the expense associated with compressor cooling air, to thereby improve the efficiency of the turbine engine.

### BRIEF DESCRIPTION OF THE INVENTION

According to one aspect of the invention, a turbine engine comprises a turbine housing, a turbine disposed in the turbine housing and configured to receive hot combustion gas, a turbine component subject to thermal energy from the hot combustion gas and a cooling system disposed externally of the turbine housing and having a cooling medium disposed therein. A heat pipe has a high temperature end in communication with the turbine component and a low temperature end extending out of the turbine housing in communication with the cooling medium in the cooling system for transferring the thermal energy from the component to the cooling medium.

According to another aspect of the invention, a turbine engine comprises a turbine housing, a turbine disposed in the turbine housing and configured to receive hot combustion gas, a turbine airfoil extending radially outwardly from a rotatable hub assembly and subject to thermal energy from the hot combustion gas and a cooling system disposed in the rotatable hub assembly having a cooling medium disposed therein. A heat pipe has a high temperature end in communication with the turbine airfoil and a low temperature end extending radially inwardly to terminate in communication with the cooling medium of the cooling system in the rotatable hub assembly for transferring the thermal energy from the turbine airfoil to the cooling medium.

According to yet another aspect of the invention, a gas turbine engine comprises a turbine, a combustor for delivery of hot combustion gas to the turbine and a nozzle assembly having nozzle airfoils and configured to receive the hot combustion gas from the combustor. The nozzle assembly is mounted within, and is fixed in relationship to, a turbine engine housing. A plurality of solid state, superconducting heat pipes are associated with the nozzle airfoils and have high temperature ends in communication with the nozzle airfoils and low temperature ends extending outwardly of the turbine engine housing. A cooling system, including a cooling medium disposed for circulation therein, is located outside of the turbine engine housing and is configured to receive the low temperature ends of the plurality of solid state, superconducting heat pipes, wherein thermal energy from the hot combustion gas is transferred from the nozzle airfoils to the cooling system through heat transfer from the high temperature ends to the low temperature ends of the heat pipes.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partially schematic, axial sectional view through a portion of an exemplary gas turbine engine in accordance with an embodiment of the invention;

FIG. 2 is an enlarged sectional view through a portion of the gas turbine engine of FIG. 1;

FIG. 3 is an enlarged view of an exemplary turbine component of the gas turbine engine of FIG. 1;

FIG. 4 is a schematic, cross sectional view of an exemplary embodiment of a heat pipe of the gas turbine engine of FIG. 1; and

FIG. 5 is a schematic, cross sectional view of another exemplary embodiment of a heat pipe of the gas turbine engine of FIG. 1.

The detailed description explains embodiments of the invention, together with advantages and features, by way of example with reference to the drawings.

### DETAILED DESCRIPTION OF THE INVENTION

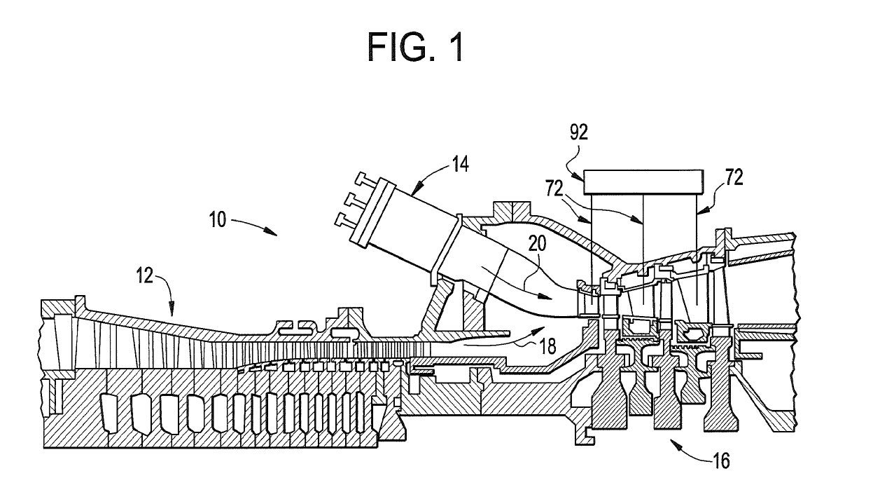

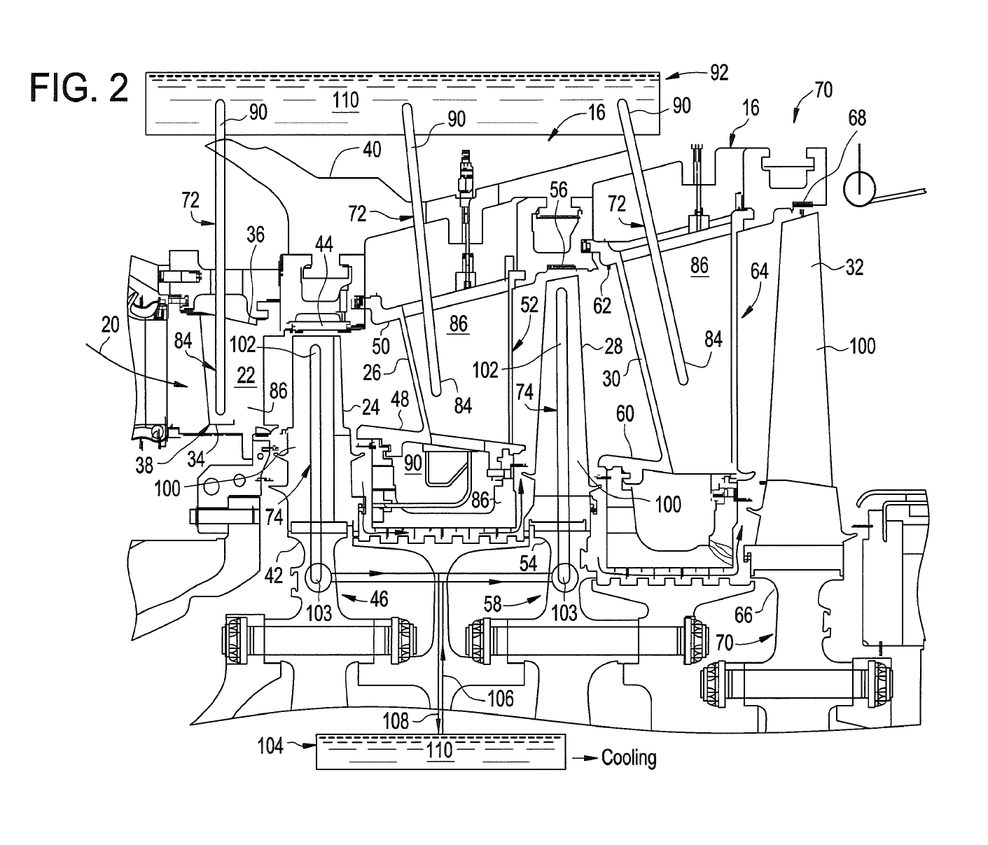

Illustrated in FIGS. 1 and 2 is a portion of a gas turbine engine 10. The engine is axisymmetrical about a longitudinal or axial centerline axis and includes, in serial flow communication, a multistage axial compressor 12, a combustor 14, and a multi-stage turbine 16.

During operation of the gas turbine engine 10, compressed air 18 from the compressor 12 flows to the combustor 14 that operates to combust fuel with the compressed air for generating hot combustion gas 20. The hot combustion gas 20 flows downstream through the multi-stage turbine 16, which extracts energy therefrom.

As shown in detail in FIG. 2, an example of a multi-stage axial turbine 16 may be configured in three stages having six rows of airfoils 22, 24, 26, 28, 30, 32 disposed axially, in direct sequence with each other, for channeling the hot combustion gas 20 therethrough and, for extracting energy therefrom.

The airfoils 22 are configured as first stage nozzle vane airfoils. The airfoils are circumferentially spaced apart from each other and extend radially between inner and outer vane sidewalls 34, 36 to define first stage nozzle assembly 38. The nozzle assembly 38 is stationary within the turbine housing 40 and operates to receive and direct the hot combustion gas 20 from the combustor 14. Airfoils 24 extend radially outwardly from the perimeter of a first supporting disk 42 to terminate adjacent first stage stationary turbine rotor shroud 44. The airfoils 24, the supporting disk 42 and the first stage stationary turbine rotor shroud 44 define the first stage turbine rotor assembly 46 that receives the hot combustion gas 20 from the first stage nozzle assembly 38 to rotate the first stage turbine rotor assembly 46, thereby extracting energy from the hot combustion gas.

The airfoils 26 are configured as second stage nozzle vane airfoils. The airfoils are circumferentially spaced apart from each other and extend radially between inner and outer vane sidewalls 48 and 50 to define second stage nozzle assembly 52. The second stage nozzle assembly 52 is stationary within the turbine housing 40 and operates to receive the hot combustion gas 20 from the first stage turbine rotor assembly 46. Airfoils 28 extend radially outwardly from a second supporting disk 54 to terminate adjacent second stage stationary turbine rotor shroud 56. The airfoils 28, the supporting disk 54 and second stage stationary turbine rotor shroud 56 define the second stage turbine rotor assembly 58 for directly receiving hot combustion gas 20 from the second stage nozzle assembly 52 for additionally extracting energy therefrom.

Similarly, the airfoils 30 are configured as third stage nozzle vane airfoils circumferentially spaced apart from each other and extending radially between inner and outer vane sidewalls 60 and 62 to define a third stage nozzle assembly 64. The third stage nozzle assembly 64 is stationary within the turbine housing 40 and operates to receive the hot combustion gas 20 from the second stage turbine rotor assembly 58. Airfoils 32 extend radially outwardly from a third supporting disk 66 to terminate adjacent third stage stationary turbine rotor shroud 68. The airfoils 32, the supporting disk 66 and third stage stationary turbine rotor shroud 68 define the third stage turbine rotor assembly 70 for directly receiving hot combustion gas 20 from the third stage nozzle assembly 64 for additionally extracting energy therefrom. The number of stages utilized in a multistage turbine 16 may vary depending upon the particular application of the gas turbine engine 10.

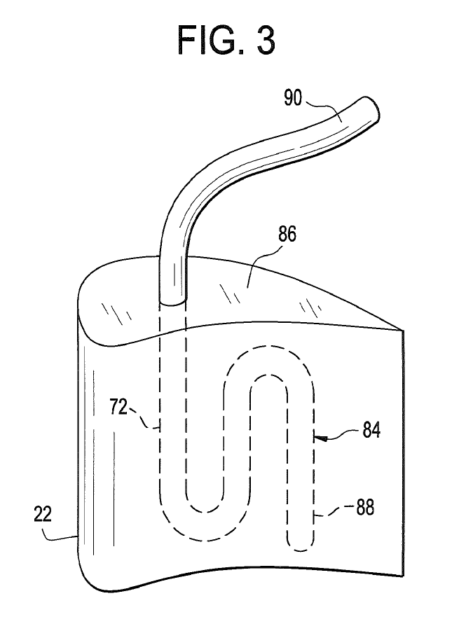

As indicated, first, second and third stage nozzle assemblies 38, 52 and 64 are stationary relative to the turbine housing 40 while the turbine rotor assemblies 46, 58 and 70 are mounted for rotation therein. The turbine airfoils and the stationary turbine rotor shrouds are exposed to the hot combustion gas 20 and the thermal energy from the hot combustion gas 20 during operation of the turbine engine 10 with the hottest components closest to the outlet of the combustor 14. To assure desired durability of such internal components they are typically cooled. As illustrated in detail in FIGS. 2 and 3, heat pipes such as nozzle airfoil heat pipes 72, turbine airfoil heat pipes 74 and stationary turbine rotor shroud heat pipes 75 may be used to effectively remove heat from internal turbine components such as airfoils 22, 24, 26, 28, 30, 32 and stationary turbine rotor shrouds 44, 56, 68 while reducing or eliminating the requirement of a coolant medium such as diverted compressor air.

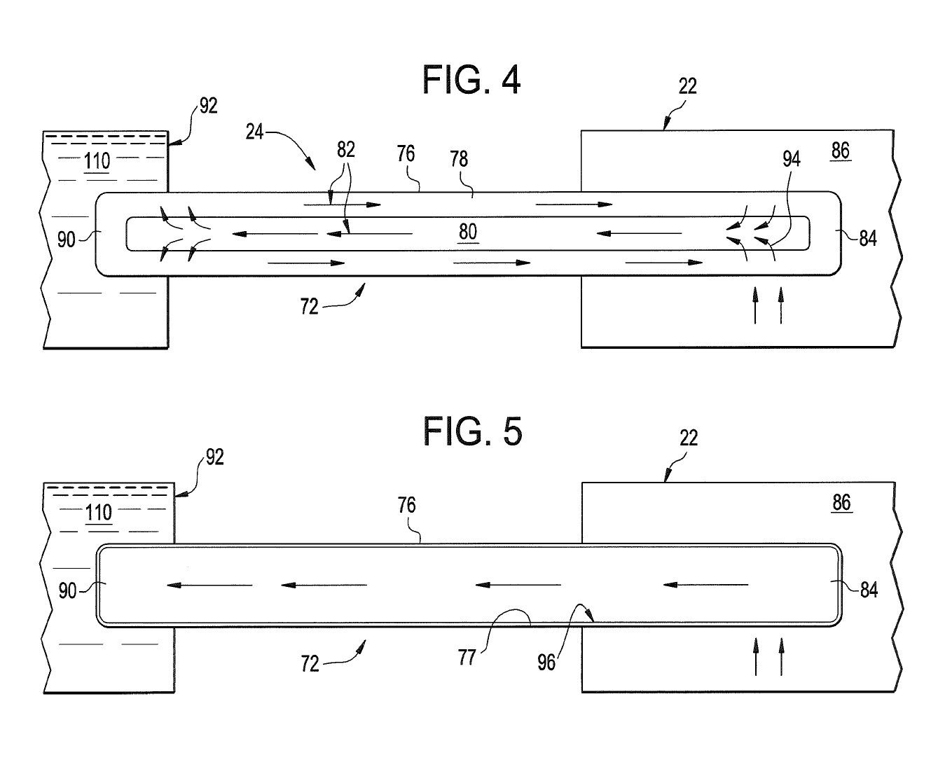

In an exemplary embodiment of a heat pipe 72, shown schematically in FIG. 4, each heat pipe is configured to remove thermal energy from a turbine component such as airfoil 22 and to transfer the thermal energy to a cooling medium. A heat pipe 72 includes a casing 76 defining an outer surface of the heat pipe. The casing 76 is sealed so as to define an internal vacuum chamber. Disposed internally of the casing 76 is an absorbent wick 78, which surrounds a vapor cavity 80. A heat transfer fluid 82 such as water, sodium or other suitable material is disposed in the vapor cavity 80. A high temperature end 84 of the heat pipe 72 is imbedded, attached to or otherwise physically associated with the body 86 of the nozzle airfoil 22. To improve the heat transfer from the body of a nozzle airfoil the high temperature end 84 of the heat pipe 72 may have a configuration defined by the shape of the turbine component so as to increase the airfoil surface area in which it is in contact. An exemplary embodiment of such a configuration is shown by serpentine end portion 88 of high temperature end 84 in FIG. 3.

A low temperature end 90 of the heat pipe 72 is disposed outside of the body 86 of the nozzle airfoil 22 and is associated with a cooling system 92. At the high temperature end 84 of the heat pipe 72, thermal energy from the body 86 of the airfoil 22 is transferred to the heat pipe causing the heat transfer fluid 82 in the absorbent wick 78 at the high temperature end 84 to evaporate into vapor 94 in the vapor cavity 80. The vapor migrates to the low temperature end 90, condenses and is reabsorbed by the absorbent wick 78 thereby releasing thermal energy. The thermal energy is removed from the heat pipe 72 by the cooling system 92 as the heat transfer fluid 82 migrates via the absorbent wick 78 back to the high temperature end 84 where the heat transfer process is repeated.

In another exemplary embodiment shown in FIG. 5, the heat pipe 72 may be of a solid state construction in which the thermal energy from the body 86 of the airfoil 22 is absorbed by a highly thermally conductive, inorganic solid heat transfer medium 96 disposed on the inner walls 77 of the casing 76 (ex. a solid state, superconducting heat pipe). An exemplary, solid state heat transfer medium 96 is applied to the inner walls 77 in three basic layers. The first two layers are prepared from solutions which are exposed to the inner wall 77 of the casing 76. Initially the first layer which primarily comprises, in ionic form, various combinations of sodium, beryllium, a metal such as manganese or aluminum, calcium, boron, and a dichromate radical, is absorbed into the inner wall 77 of the casing 76 to a depth of 0.008 mm to 0.012 mm. Subsequently, the second layer which primarily comprises, in ionic form, various combinations of cobalt, manganese, beryllium, strontium, rhodium, copper, B-titanium, potassium, boron, calcium, a metal such as aluminum and the dichromate radical, builds on top of the first layer and forms a film having a thickness of 0.008 mm to 0.012 mm over the inner wall 77 of the casing 76. Finally, the third layer is a powder comprising various combinations of rhodium oxide, potassium dichromate, radium oxide, sodium dichromate, silver dichromate, monocrystalline silicon, beryllium oxide, strontium chromate, boron oxide, B-titanium and a metal dichromate, such as manganese dichromate or aluminum dichromate, which evenly distributes itself across the inner wall 77. The three layers are applied to the casing 76 and are then heat polarized to form a superconducting heat pipe 72 that transfers thermal energy with little or no net heat loss. The process used to construct the heat pipe 72 may be any suitable method such as, for instance, the method described in U.S. Pat. No. 6,132,823, issued Oct. 17, 2000 and entitled Superconducting Heat Transfer Medium.

The inorganic compounds utilized in such an application are typically unstable in air, but have high thermal conductivity in a vacuum. Thermal energy from the airfoil 22 migrates, via the solid heat transfer medium 96 from the high temperature end 84 to the low temperature end 90 of the heat pipe 72 where the thermal energy is removed from the heat pipe by the cooling system 92.

Referring again to FIG. 2, nozzle airfoil heat pipes 72 (shown schematically) may be disposed within the bodies 86 of the nozzle airfoils 22, 26 and 30 and stationary turbine rotor shroud heat pipes 75 (shown schematically) may be disposed within the stationary turbine rotor shrouds 44, 56, 68. The heat pipes may be formed in place as part of the manufacturing process of the turbine components (ex. casting in place) or may be mechanically installed (ex. welding, bonding) following construction. Each heat pipe extends radially outwardly of its respective nozzle airfoil or turbine rotor shroud and through the turbine housing 40. In an exemplary embodiment, a cooling system 92 (shown schematically) that receives the low temperature ends 90 of the heat pipes 72 is located externally of the turbine housing. A cooling medium such as water 110, or other suitable coolant, is circulated through the cooling system 92 and operates to remove thermal energy from the low temperature ends 90.

In another embodiment, turbine airfoil heat pipes 74 (shown schematically) may be disposed within the bodies 100 of the turbine airfoils 24, 28 and 32 (not shown in turbine airfoil 32). The high temperature ends 102 of the heat pipes 74 are exposed to, and remove thermal energy from, the airfoil bodies 100. Low temperature ends 103 of the turbine airfoil heat pipes 74 extend radially inwardly to communicate with turbine rotor cooling system 104. The turbine rotor cooling system may include cooling medium supply and return conduits 106 and 108 respectively, which are configured to circulate a cooling medium such as water 110. The low temperature end 103 of each turbine airfoil heat pipe 74 is associated with the cooling medium 110 supplied by the turbine rotor cooling system 104 (shown schematically) that is configured to, and operates to, remove thermal energy from the low temperature ends 103 and, accordingly, from the turbine airfoil body 100. The use of the turbine airfoil heat pipes 74 to remove thermal energy from the turbine airfoils may eliminate or reduce the need for the diversion of compressor air for the purpose of cooling the turbine components resulting in an increase in efficiency of the gas turbine engine 10.

While exemplary embodiments of the invention have been described with application primarily to turbine and nozzle airfoils and stationary turbine rotor shrouds of a multi-stage turbine, the description is for simplification only and the scope of the invention is not intended to be limited to those particular applications. The application of the described invention can be applied to similar turbine engine assemblies and components throughout the various stages.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A turbine engine comprising:
a turbine housing;
a turbine disposed in the turbine housing and configured to receive hot combustion gas;
a turbine component subject to thermal energy from the hot combustion gas;
a cooling system disposed externally of the turbine housing and having a cooling medium disposed therein; and
a heat pipe having a high temperature end in communication with the turbine component and a low temperature end extending out of the turbine housing, the low temperature end in communication with the cooling medium in the cooling system for transferring the thermal energy from the component to the cooling medium.

2. The turbine engine of claim 1, the heat pipe further comprising;
a casing defining a vacuum sealed inner chamber; and
a heat transfer medium disposed within the vacuum sealed inner chamber of the casing and configured to transfer the thermal energy from the high temperature end of the heat pipe to the low temperature end of the heat pipe for release of the thermal energy to the cooling medium.

3. The turbine engine of claim 2, wherein the heat transfer medium comprises one or more solid layers applied to an interior wall of the casing.

4. The turbine engine of claim 1 wherein the turbine component is a stationary turbine nozzle.

5. The turbine engine of claim 1 wherein the component is a stationary turbine rotor shroud.

6. The turbine engine of claim 1 further comprising;
a circulation system associated with the cooling system and configured to circulate the cooling medium through the cooling system to facilitate transfer of thermal energy from the heat pipe to the cooling medium.

7. The turbine engine of claim 1 wherein the turbine component is a turbine airfoil extending radially outwardly from a rotatable hub assembly, the turbine airfoil having the high temperature end of the heat pipe in communication therewith and the low temperature end of the heat pipe extending radially inwardly to terminate in the rotatable hub assembly.

8. The turbine engine of claim 7 further comprising:
a cooling system disposed in the rotatable hub assembly having a cooling medium disposed therein and in communication with the low temperature end of the heat pipe.

9. The turbine engine of claim 8, further comprising:
a circulation system associated with the cooling system disposed in the rotatable hub assembly and configured to circulate the cooling medium through the cooling system to facilitate transfer of thermal energy from the heat pipe to the cooling medium.

10. A turbine engine comprising:
a turbine housing
a turbine disposed in the turbine housing and configured to receive hot combustion gas;
a turbine airfoil extending radially outwardly from a rotatable hub assembly and subject to thermal energy from the hot combustion gas;
a cooling system disposed in the rotatable hub assembly having a cooling medium disposed therein; and
a heat pipe having a high temperature end in communication with the turbine airfoil and a low temperature end extending radially inwardly to terminate in communication with the cooling medium of the cooling system in the rotatable hub assembly for transferring the thermal energy from the turbine airfoil to the cooling medium.

11. The turbine engine of claim 10, the heat pipe further comprising;
a casing defining a vacuum sealed inner chamber; and
a heat transfer medium disposed within the vacuum sealed inner chamber of the casing and configured to transfer the thermal energy from the high temperature end of the heat pipe to the low temperature end of the heat pipe for release of the thermal energy to the cooling medium.

12. The turbine engine of claim 11, wherein the heat transfer medium comprises one or more solid layers applied to an interior wall of the casing.

13. A gas turbine engine comprising;
a turbine;
a combustor for delivery of hot combustion gas to the turbine;
a nozzle assembly having nozzle airfoils and configured to receive the hot combustion gas from the combustor, the nozzle assembly mounted within, and fixed in relationship to, a turbine engine housing;
a plurality of solid state, superconducting heat pipes associated with the nozzle airfoils and having high temperature ends in communication with the nozzle airfoils and low temperature ends extending outwardly of the turbine engine housing; and
a cooling system, including a cooling medium disposed for circulation therein, located outside of the turbine engine housing and configured to receive the low temperature ends of the plurality of solid state, superconducting heat pipes, wherein thermal energy from the hot combustion gas is transferred from the nozzle airfoils to the cooling system through heat transfer from the high temperature ends to the low temperature ends of the heat pipes.

14. The gas turbine engine of claim 13, further comprising;
a rotor assembly disposed for rotation in the turbine housing;
turbine airfoils extending radially outwardly from the rotor assembly and configured to receive the hot combustion gas from the nozzle assembly;
solid state, superconducting heat pipes associated with the turbine airfoils and having high temperature ends in communication therewith and low temperature ends extending radially inwardly therefrom; and
a rotor assembly cooling system, including a cooling medium for circulation therein, configured to receive the low temperature ends of the solid state, superconducting heat pipes wherein thermal energy from the hot combustion gas is transferred from the turbine airfoils to the rotor assembly cooling system by heat transfer from the high temperature ends to the low temperature ends of the heat pipes.

15. The gas turbine engine of claim 14, further comprising;
a cooling medium supply conduit and a cooling medium return conduit configured to circulate the cooling medium to the turbine airfoils.

16. The gas turbine engine of claim 13, further comprising:
a stationary turbine rotor shroud configured to receive the hot combustion gas from the combustor, the stationary turbine rotor shroud mounted within, and fixed in relationship to, the turbine housing;
solid state, superconducting heat pipes associated with the stationary turbine rotor shroud and having high temperature ends in communication therewith and low temperature ends extending outwardly of the turbine engine casing; and
a cooling system, including a cooling medium disposed for circulation therein, located outside of the turbine engine casing and configured to receive the low temperature ends of the heat pipes, wherein thermal energy from the hot combustion gas is transferred from the stationary turbine rotor shroud to the cooling system by heat transfer from the high temperature ends to the low temperature ends of the heat pipes.
